(19) United States
(12) Patent Application Publication
(10) Pub. No.: US 2012/0040628 A1
(43) Pub. Date: Feb. 16, 2012

(54) Transceiver with Interferer Control

(75) Inventors: Erwin Krug, Munich (DE); Peter Laaser, Munich (DE); Jiang Wang, Xian (CN)

(73) Assignee: Infineon Technologies AG, Neubiberg (DE)

(21) Appl. No.: 12/855,748

(22) Filed: Aug. 13, 2010

(51) Int. Cl. H04B 1/40

(52) U.S. Cl. 455/86

(57) ABSTRACT

Some embodiments of the present disclosure relate to a transceiver that includes multiple communication subunits associated with multiple communication protocols, respectively. The transceiver includes a conflict detection and control unit that determines whether interference is present or anticipated to occur between two or more of the communication subunits. If interference is present or anticipated, a local oscillator (LO) tuning unit changes an LO frequency provided to at least one of the two or more communication units. For example, in some embodiments, the LO tuning unit changes the LO frequency from high-side injection to low-side injection, or vice versa, or changes the intermediate frequency (IF) associated with a given communication subunit. In these ways, the techniques disclosed herein limit signal degradation due to interference from communication subunits residing within the transceiver.

### BACKGROUND

Modern mobile phone transceivers can support transmission and reception of data over a wide array of communication protocols, such as Global System for Mobile Communications (GSM), Bluetooth, FM radio, 3G, 4G, infrared, etc. In some instances, each of these communication protocols is carried out in the mobile phone transceiver by its own hardware subunit. For example, GSM communication can be carried out by a GSM hardware subunit, and FM radio reception can be carried out by another, separate FM Radio (FMR) hardware subunit.

Although these subunits may share some components, they often include distinct communication paths so they can transmit and/or receive data concurrently. On each path, a mixer often receives a local oscillator (LO) signal to convert the frequency of a signal-of-interest to another desired frequency. The inventors have appreciated that interference can arise when a harmonic of an LO signal over a second communication path (e.g., in an FMR subunit) downconverts a transmit signal of a first communication path (e.g., in a GSM subunit). This cross-talk interference can degrade the sensitivity of the second communication path. Similarly, LO harmonics generated by the first communication path can parasitically affect the second communication path.

Therefore, the inventors have devised improved transceivers that limit degradation between communication units within mobile phones and other communication devices.

### DESCRIPTION OF THE DRAWINGS

FIG. 1 is a block diagram illustrating a transceiver in accordance with some embodiments.

FIGS. 2A-2B collectively illustrate a more detailed example of transceiver functionality with sample frequency channels superimposed thereon.

FIG. 3 is a block diagram illustrating another transceiver in accordance with some embodiments.

FIG. 4 is a flow chart depicting a method in accordance with some embodiments.

FIGS. 5A-5D collectively show an example method of changing an LO frequency in the context of a set of sample frequency diagrams.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details.

Some embodiments of the present disclosure relate to a transceiver that includes multiple communication subunits associated with multiple communication protocols, respectively. The transceiver includes a conflict detection and control unit that determines whether interference is present or anticipated to occur between two or more of the communication subunits. If interference is present or anticipated, a local oscillator (LO) tuning unit changes an LO frequency provided to at least one of the two or more communication units. For example, in some embodiments, the LO tuning unit changes the LO frequency from high-side injection to low-side injection, or vice versa, and/or changes an intermediate frequency (IF) associated with a given communication subunit. In these ways, the techniques disclosed herein limit signal degradation due to interference from communication subunits residing within the transceiver.

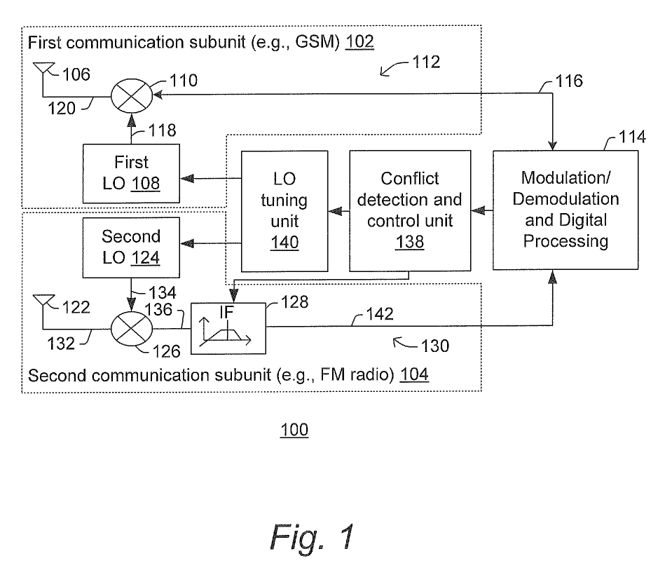

Referring now to FIG. 1, one can see a transceiver 100 in accordance with some embodiments. The illustrated transceiver 100 includes first and second communication subunits 102, 104, respectively, which can be used to transmit and/or receive signals according to a first communication protocol (e.g., GSM) and a second communication protocol (e.g., FM radio), respectively. Although only two communication subunits are illustrated, it will be appreciated that the inventive concepts can be extended to any number of communication subunits, and/or to other communication protocols in addition to or instead of GSM and FM radio.

In any case, each subunit includes one or more communication paths on which signals are transmitted and/or received. For example, in FIG. 1's embodiment, the first subunit 102 includes a first communication path 112 having a first antenna 106, a first local oscillator 108, and a first mixer 110; which are operably coupled as shown. When the first communication subunit 102 acts as a transmitter, a digital block 114 provides a first signal 116 to a first input of the first mixer 110. The first mixer 110 then multiplies the first signal 116 with a first LO signal 118 to produce an up-converted RF signal 120, which can be transmitted over the first antenna 106.

The illustrated second subunit 104 includes a second communication path 130 having a second antenna 122, a second LO 124, a second mixer 126, and a filter unit 128; which are operably coupled as shown. When the second subunit acts as a receiver, the second antenna 122 provides an RF signal 132, which includes a wanted signal, to a first input of the second mixer 126. The second mixer 126 mixes the wanted signal with a second LO signal 134 from the second LO 124, and provides a down-converted wanted signal 136 (e.g., IF signal) therefrom. The down-converted wanted signal 136 is then passed through the filter block 128, which rejects unwanted frequency components, to provide a filtered signal 142 which can be demodulated and otherwise processed in digital circuitry 114.

Absent countermeasures, the first signal 116 or first LO signal 118 (and/or a harmonic frequency thereof) can lead to interference on the second communication path 130. To limit or avoid such interference, a conflict detection and control unit 138 monitors the frequencies of the first and second LO signals 118, 134 and harmonics thereof in relation to the frequencies being transmitted or received on the communication paths 112, 130.

If a conflict is detected, the conflict detection and control unit 138 notifies an LO tuning unit 140, which selectively adjusts the frequency of the second LO signal 134 to mitigate the interference. In particular, the LO tuning unit 140 can induce a discrete change in the frequency of the second LO signal 134 such that the second LO signal is changed between a low-side injection mode and a high-side injection mode without changing an intermediate frequency (IF) associated with the corresponding communication path. In other embodiments, the detection and control unit 138 can change the frequency of the second LO signal 134 in a manner that changes the IF to limit or avoid interference. When the IF is adjusted, the conflict detection and control unit 138 also typically adjusts the passband of filter block 128 to allow the newly “tuned” IF to pass therethrough.

By continuously or intermittently monitoring the LO frequencies used by the various communication subunits (and harmonics associated therewith), and comparing these frequencies with the frequencies used for transmission and reception of RF signals, the disclosed techniques provide more efficient communication than previous solutions in some respects.

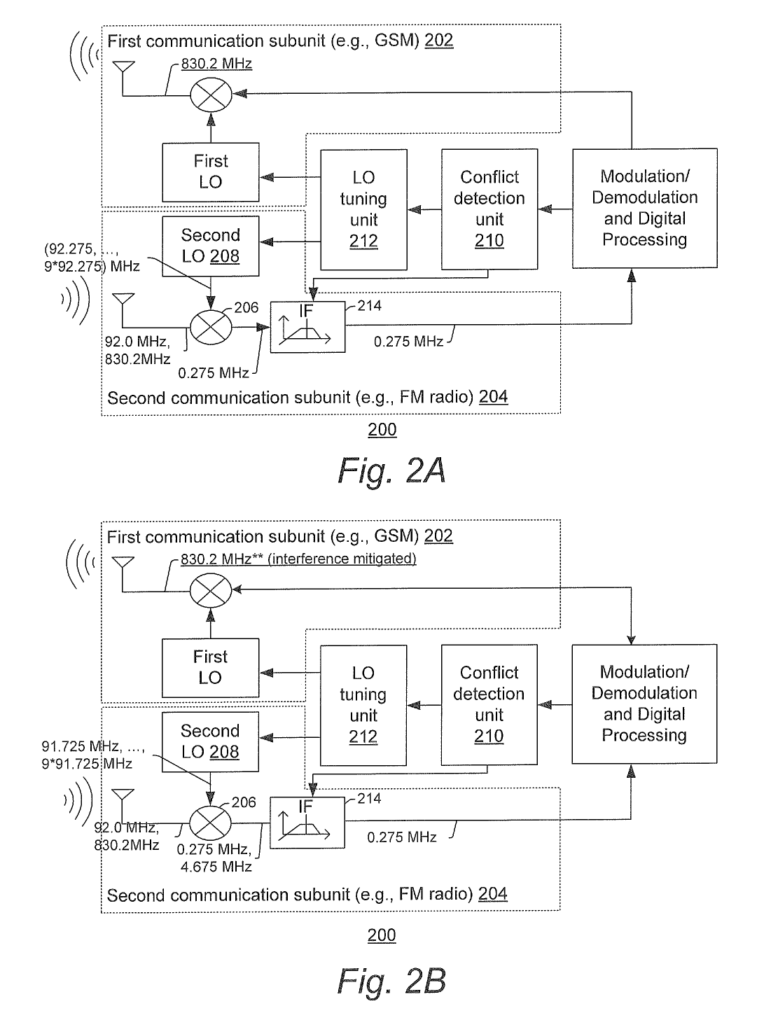

Referring now to FIGS. 2A-2B collectively, one can see a more detailed example of how a transceiver 200 (e.g., transceiver 100 of FIG. 1) can change between high-side LO injection (FIG. 2A) and low-side LO injection (FIG. 2B) for a given communication path to limit interference between two communication subunits.

FIG. 2A shows an example where the transceiver 200 transmits a GSM signal at 830.2 MHz via the first communication subunit 202 (GSM subunit) while concurrently receiving an FM signal at 92.0 MHz via the second communication subunit 204 (FM subunit). At this time, the FM subunit 204 is poised to use a high-side LO frequency of 92.275 MHz to down-convert the received 92.0 MHz FM signal to an IF of 0.275 MHz. However, the LO signal includes a fundamental frequency and harmonic frequencies, which are integer multiples of the fundamental frequency. In particular in FIG. 2A, one of these harmonic frequencies, (e.g., the ninth harmonic of the second LO signal at 9×92.275 MHz=830.475 MHz), coincides with the sum of the GSM transmission channel frequency and the IF frequency (e.g., 830.2 MHz+0.275 MHz=830.475 MHz). Hence, when “high-side” injection is used, the ninth harmonic of the high-side LO signal at 830.475 MHz from the second LO 208 downconverts the 830.2 MHz frequency channel used for GSM transmission to 0.275 MHz. The downconverted signal appears at 0.275 MHz, i.e. within the passband of the second communication unit, leading to unwanted GSM signals passing through the filter 214 and causing FM Radio distortion.

The conflict detection and control unit 210 monitors the frequencies (and associated harmonics) of the LO signals and any transmitted or received signals. In the case of FIG. 2A, the conflict detection and control unit 210 detects that the ninth harmonic of the 92.275 MHz LO frequency and 830.2 MHz signal of the GSM signal cause interference in the FMR subunit 204, so it instructs the LO tuning unit 212 to tune the second LO signal to a low-side LO frequency of 91.725 MHz, as shown in FIG. 2B. This switch from high-side injection (FIG. 2A) to low-side injection (FIG. 2B) mitigates the interference in the FMR subunit 204 without changing the IF (0.275 MHz) on the FM reception path. More particularly, in FIG. 2B the ninth harmonic of the second LO signal at 825.525 MHz converts the GSM transmission channel at 830.2 MHz down to 4.625 MHz (=830.2 MHz−825.525 MHz). The frequency of the downconverted signal is outside the passband of the filter in the FM subunit 204 Further, because the IF remains unchanged at 0.275 MHz in the FM subunit 204, the filter block 214 can keep its previous filter characteristics. In other embodiments the switch could be from low-side injection to high-side injection and/or could alter the IF in the second communication path, depending on the implementation.

It will be appreciated that the frequencies in FIGS. 2A-2B are merely examples and that the concepts described herein are applicable to any frequencies and not limited to these examples in any way. Further, in some embodiments it will be appreciated that an IF of zero can be used. Thus, the frequencies used will vary widely depending on the communication protocols involved, as well as what particular channels within a given communication protocol are being used, as well as other factors.

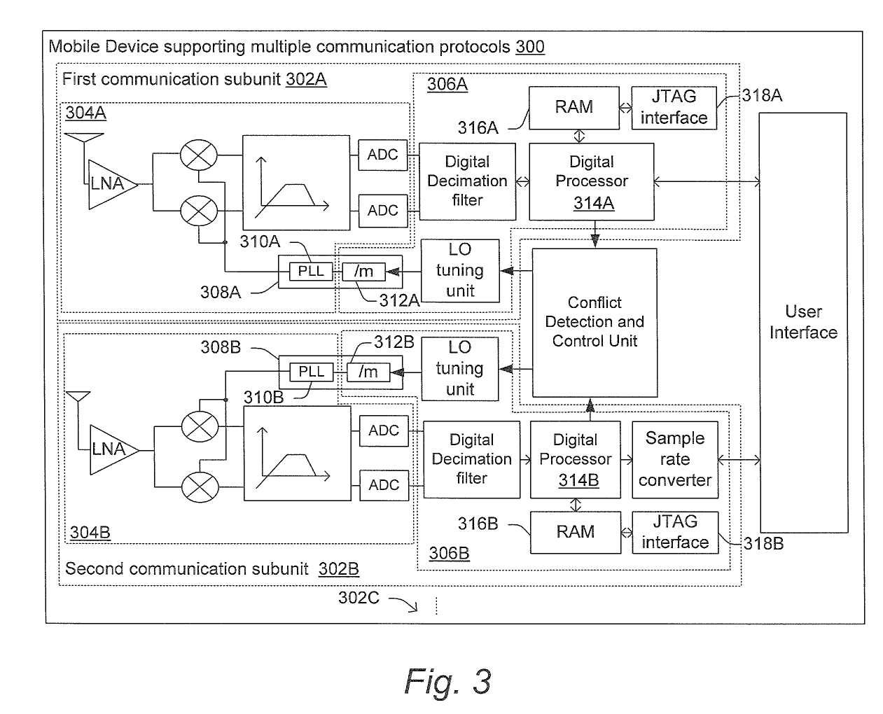

FIG. 3 shows another embodiment of a mobile device 300 that supports multiple communication protocols. The mobile device includes a first communication subunit 302A, a second communication subunit 302B, as well as one or more additional communication subunits 302C (not shown in detail).

Each subunit can include one or more communication paths that include an analog front end (e.g. 304A, 304B) and digital circuitry (e.g., 306A, 306B), wherein an analog-to-digital converter (ADC) or digital-to-analog converter (DAC) is disposed therebetween, depending on whether the communication path is used for reception or transmission. Within the analog front ends, one or more local oscillators (LOs) (e.g., 308A, 308B), which can comprise a phase-locked loop (e.g., 310A, 310B) and a fractional divider (e.g., 312A, 312B) in some instances, provide LO signals to the communication paths. Within the digital circuitry, a digital processor (e.g., 314A, 314B), memory (316A, 316B), and JTAG interface (318A, 318B) are often found.

Although FIG. 3 shows separate hardware blocks on each path, some of these hardware blocks may be shared between various communication subunits. For example, in some embodiments, two or more communication subunits can share an antenna. In such an instance, a duplexer or other switching element typically selectively couples the communication paths to the shared antenna. In these and other embodiments, the memory units and/or digital processor can also be shared between the communication subunits. Other variations are also possible, with all such variations falling within the scope of the present invention.

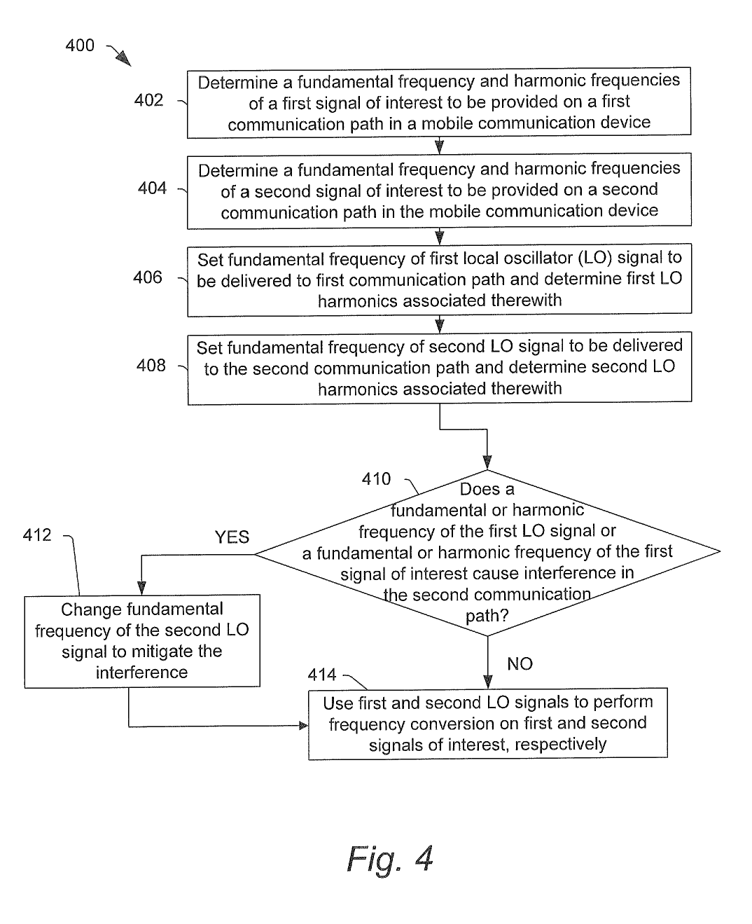

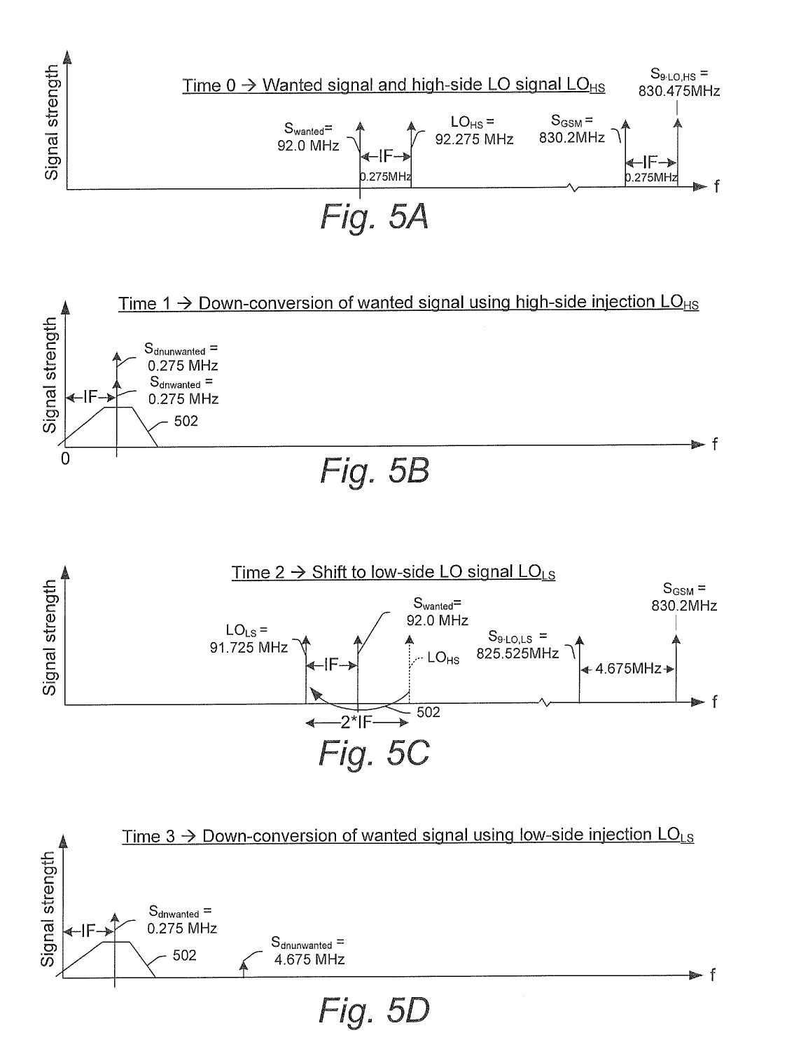

FIGS. 4-5 show some methods in accordance with some embodiments of the present disclosure. While these methods are illustrated and described below as a series of acts or events, the present disclosure is not limited by the illustrated ordering of such acts or events. For example, some acts may occur in different orders and/or concurrently with other acts or events apart from those illustrated and/or described herein. In addition, not all illustrated acts are required and the waveform shapes are merely illustrative and other waveforms may vary significantly from those illustrated. Further, one or more of the acts depicted herein may be carried out in one or more separate acts or phases. It will also be appreciated that the communication devices previously illustrated in FIGS. 1-3 can include suitable hardware and/or software to implement these methods.

FIG. 4 relates to a method for mitigating interference between signals communicated over first and second communication paths in a mobile device. The method starts at 402, when the method determines a fundamental frequency and harmonic frequencies of a first signal-of-interest to be provided on a first communication path in the mobile communication device.

At 404, the method determines a fundamental frequency and harmonic frequencies of a second signal-of-interest to be provided on a second communication path in the mobile communication device. Typically the fundamental frequency of the second signal-of-interest differs from the fundamental frequency of the first signal-of-interest. For example, consistent with the example previously discussed in FIG. 2A-2B, the fundamental frequency of the first signal-of-interest could be a GSM transmission frequency of 830.2 MHz, and the fundamental frequency of the second signal-of-interest could be a FM radio frequency of 92.0 MHz.

At 406, the method sets a fundamental frequency of a first LO signal. This first LO signal is to be provided on the first communication path to convert (e.g., up-convert) the fundamental frequency of the first signal. The method also determines first LO harmonics associated the first LO signal in 406.

At 408, the method sets a fundamental frequency of a second LO signal. This second LO signal is to be provided on the second communication path to convert (e.g., down-convert) the fundamental frequency of the second signal. The method also determines second LO harmonics associated the second LO signal in 408.

The method then proceeds to 410 and determines whether the fundamental or harmonic frequencies of the first signal or the fundamental or harmonic frequencies of the first LO signal cause interference in the second communication channel 420. If so (‘YES’ at 410), the method changes the fundamental frequency of the second LO signal to mitigate the conflict in 412.

If not (‘NO’ at 410), there is no detected conflict and the method proceeds to 414 where it uses the first and second LO signals to perform frequency conversion on the first and second signals of interest, respectively.

FIGS. 5A-5B show frequency diagrams consistent with one embodiment of the present disclosure. These frequency diagrams collectively show one manner in which a transceiver (e.g., transceiver of FIG. 1, FIG. 2, or FIG. 3) can change between high-side LO injection (FIG. 5A) and low-side LO injection (FIG. 5B) to limit interference between two communication subunits.

FIG. 5A deals with an example where the transceiver transmits a GSM signal at 830.2 MHz over a first communication path (not shown) while concurrently receiving a wanted signal at 92.0 MHz on a second frequency path. The wanted signal is mixed with a high-side LO frequency LO_{HS} having a fundamental frequency of 92.275 MHz, which is separated from the frequency of the wanted signal by an intermediate frequency IF of 0.275 MHz.

Furthermore, the ninth harmonic of the LO frequency is located at 830.475 MHz, which is separated from the frequency of the GSM by an intermediate frequency IF of 0.275 MHz, too.

As shown in FIG. 5B, when the 92.0 MHz signal is mixed with the LO_{HS} signal. The downconverted signal S_{dnwanted}, appears at 0.275 MHz. In addition, the 830.2 MHz GSM signal is mixed with the ninth harmonic of the LO_{Hs} signal and the downconverted signal S_{dnunwanted} occurs at 0.275 MHz, too. The unwanted signal S_{dnunwanted} interferes with the wanted signal S_{dwanted} and decreases the sensitivity of the second communication unit.

Consequently, to limit interference/cross-talk, the frequency of the LO_{HS} signal is shifted to LO_{Ls} (see arrow 504), as shown in FIG. 5C. This switch from high-side injection to low-side injection, which occurs symmetrically about the wanted signal (i.e., +/− IF with regards to the frequency of the wanted signal), mitigates interference while leaving the IF unchanged. Consequently, as shown in FIG. 5D, the end result of the shift is that the IF of the down-converted wanted signal remains the same (0.275 MHz) so it passes through the filter. The ninth harmonic of the low-side LO signal is located at 825.525 MHz and converts the GSM signal at 830.2 MHz down to 4.625 MHz, so it is attenuated by the filter. Notably, the cross-talk interference from the first to second communication unit is mitigated.

It will be appreciated that the frequencies in FIGS. 5A-5D are merely examples and that the concepts described herein are applicable to any frequencies and not limited to these examples in any way. For example, in some embodiments it will be appreciated that an IF of zero can be used. In other embodiments, the LO frequency can be shifted by than greater than 2*IF or by less than 2*IF, thereby causing a shift in the IF. These shifts can also be used to mitigate the interference, although they typically require a tunable filter with an adjustable frequency passband to allow the newly tuned mixing products of interest to pass therethrough. Thus, the frequencies used will vary widely depending on the communication protocols involved, as well as what particular channels within a given communication protocol are being used, as well as other factors.

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements and/or resources), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. In addition, the articles “a” and “an” as used in this application and the appended claims are to be construed to mean “one or more”.

Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A communication device, comprising:
a first communication unit to transmit or receive a first signal over a first frequency channel via a first communication path in the communication device;
a second communication unit to transmit or receive a second signal over a second frequency channel via a second communication path in the communication device, wherein the second communication unit provides an LO signal to the second communication path, which frequency converts the second signal; and
a conflict detection and control unit to determine whether present or anticipated communication for the first communication unit interferes with present or anticipated communication for the second communication unit and selectively adjust a frequency of the LO signal based on whether interference is present or anticipated from the first to the second communication unit.

2. The communication device of claim 1, wherein the conflict detection and control unit analyzes whether interference is present or anticipated by evaluating whether a fundamental or harmonic frequency of the LO signal exhibits a predetermined relationship with the first frequency channel used on the first communication path.

3. The communication device of claim 1, wherein the second communication unit comprises:
a mixer to receive the second signal and the LO signal, and adapted to provide a frequency converter signal that includes multiple frequencies that are a function of the second signal and the LO signal; and
a filter downstream of the mixer and adapted to pass a first of the multiple frequencies therethrough while blocking a second of the multiple frequencies.

4. The communications device of claim 3, wherein the conflict detection and control unit adjusts the frequency of the LO signal by a frequency amount equal to twice the frequency of the first of the multiple frequencies passed through the filter.

5. The communication device of claim 4, wherein the conflict detection and control unit adjusts the frequency of the LO signal without altering the filter.

6. The communication device of claim 3, wherein the conflict detection and control unit adjusts a passband of the filter, and correspondingly adjusts the frequency of the LO signal so a signal output by the mixer passes through the passband of the filter.

7. The communications device of claim 6, wherein the conflict detection and control unit adjusts the frequency of the LO signal by a frequency greater than twice a center frequency of the passband.

8. The communications device of claim 6, wherein the conflict detection and control unit adjusts the frequency of the LO signal by a frequency less than twice a center frequency of the passband.

9. A method, comprising:
communicating first and second signals according to first and second communication paths, respectively, wherein a first local oscillator (LO) signal is used to frequency convert the first signal and wherein a second LO signal is used to frequency convert the second signal;
analyzing whether the first signal or a harmonic frequency associated therewith or first LO signal or a harmonic frequency associated therewith is presently causing or anticipated to lead to interference on the second communication path; and
selectively adjusting the second LO signal based on whether interference is present or anticipated, thereby limiting interference from the first to the second communication path.

10. The method of claim 9, wherein frequency convert the second signal further comprises:
mixing the second LO signal with the second signal to provide a frequency-converted signal that includes a number of intermodulation products.

11. The method of claim 10, further comprising:
filtering the frequency-converted signal to allow a frequency-converted wanted signal to pass while blocking other unwanted intermodulation products.

12. The method of claim 11, wherein the second LO signal is selectively adjusted by a frequency equal to twice the frequency of the frequency-converted wanted signal.

13. The method of claim 11, wherein the second LO signal is selectively adjusted by a frequency other than twice the frequency of the frequency-converted wanted signal.

14. The method of claim 11, wherein the first communication path is utilized for communication according to a first communication protocol, and wherein the second communication path is utilized for communication according to a second, different communication protocol.

15. A communication device, comprising:
a first communication path on which a first signal-of-interest is received, wherein the first communication path includes a first mixer having first and second mixer inputs and a mixer output, the first signal-of-interest being provided to the first mixer input;
a first local oscillator (LO) to provide a first LO signal to the second mixer input so the first mixer provides a first frequency converted signal based on the first signal-of-interest and the first LO signal;
a second communication path on which a second signal-of-interest is received, wherein the second communication path includes a second mixer having first and second mixer inputs and a mixer output, the second signal-of-interest being provided to the first mixer input of the second mixer;
a second local oscillator (LO) to provide a second LO signal to the second mixer input of the second mixer so the second mixer provides a second frequency converted signal based on the second signal-of-interest and the second LO signal;
a conflict detection and control unit to determine whether present or anticipated communication for the first communication path interferes to present or anticipated communication for the second communication path.

16. The communication device of claim 15, wherein the conflict detection and control unit analyzes whether interference is present or anticipated by evaluating whether a fundamental or harmonic frequency of the first LO signal exhibits a predetermined relationship with a fundamental frequency on the second communication path.

17. The communication device of claim 15, further comprising:
an LO tuning module to selectively adjust a frequency of at least one of the first or second LO signals based on whether interference is present or anticipated between the first and second communication paths.

18. The communication device of claim 17, wherein the second frequency converted signal includes multiple frequencies that are a function of the second signal and the second LO signal, and wherein the second communication path further comprises:
a filter downstream of the second mixer to pass a first of the multiple frequencies therethrough while blocking a second of the multiple frequencies.

19. The communications device of claim 18, wherein the LO tuning module adjusts the frequency of the second LO signal by a frequency equal to twice the first of the multiple frequencies.

20. The communication device of claim 19, wherein the LO tuning module adjusts the frequency of the second LO signal without altering the filter.

21. The communication device of claim 18, wherein the LO tuning module adjusts filter characteristics of the filter; and correspondingly adjusts a frequency of an LO signal so a signal output by the mixer exhibits the adjusted frequency component to be passed through the filter.
